(19) United States
(12) Patent Application Publication
(10) Pub. No.: US 2025/0181598 A1
(43) Pub. Date: Jun. 5, 2025

(54) EVENT SEQUENCE DATA DISPLAY

(71) Applicant: Tencent Technology (Shenzhen) Company Limited, Sjenzhen (CN)

(72) Inventors: Zhiyong WANG, Shenzhen (CN); Kunli DENG, Shenzhen (CN); Canhui HUANG, Shenzhen (CN)

(73) Assignee: Tencent Technology (Shenzhen) Company Limited, Shenzhen (CN)

(21) Appl. No.: 19/045,377

(22) Filed: Feb. 4, 2025

Related U.S. Application Data
(63) Continuation of application No. PCT/CN2023/129266, filed on Nov. 2, 2023.

(30) Foreign Application Priority Data
Jan. 9, 2023 (CN) 202310029659.9

(51) Int. Cl. G06F 16/248; G06F 16/22

(52) U.S. Cl. CPC G06F 16/248; G06F 16/2246

(57) ABSTRACT

In a method for displaying event sequence data, a visual representation corresponding to an event sequence data set is displayed. The visual representation is formed by splicing a plurality of polygons. Each of the plurality of polygons corresponds to a respective piece of the event sequence data in the event sequence data set. The respective piece of the event sequence data indicates a sequence formed by events. When an operation is performed on a first polygon in the visual representation, the event sequence data corresponding to the first polygon is displayed. Apparatus and non-transitory computer-readable storage medium counterpart embodiments are also contemplated.

### RELATED APPLICATIONS

The present application is a continuation of International Application No. PCT/CN2023/129266, filed on Nov. 2, 2023, which claims priority to Chinese Patent Application No. 202310029659.9, filed on Jan. 9, 2023. The entire disclosures of the prior applications are hereby incorporated by reference.

### FIELD OF THE TECHNOLOGY

This application relates to the field of data visualization, including an event sequence data display method.

### BACKGROUND OF THE DISCLOSURE

An event sequence refers to a sequence formed by one or more events.

In related art, in order to show a plurality of event sequences, the event sequences are shown in a list form, each event sequence occupies a line of list, and attribute parameters, such as the starting time, duration and occurrence place of each event sequence are shown in a text form.

However, if too many event sequences need to be shown, a larger display image is needed in the related art to show these event sequences, so a space utilization rate of the display image is low.

### SUMMARY

Aspects of this disclosure include an event sequence data display method, an apparatus, and a non-transitory computer-readable storage medium, and a space utilization rate of a display image required for event sequence display may be improved. Examples of technical solutions of this disclosure may be implemented as follows:

An aspect of this disclosure provides a method for displaying event sequence data. A visual representation corresponding to an event sequence data set is displayed. The visual representation is formed by splicing a plurality of polygons. Each of the plurality of polygons corresponds to a respective piece of the event sequence data in the event sequence data set. The respective piece of the event sequence data indicates a sequence formed by events. When an operation is performed on a first polygon in the visual representation, the event sequence data corresponding to the first polygon is displayed.

An aspect of this disclosure provides an apparatus. The apparatus includes processing circuitry configured to display a visual representation corresponding to an event sequence data set. The visual representation is formed by splicing a plurality of polygons. Each of the plurality of polygons corresponds to a respective piece of event sequence data in the event sequence data set. The respective piece of the event sequence data indicates a sequence formed by events. When an operation is performed on a first polygon in the visual representation, the processing circuitry is configured to display the event sequence data corresponding to the first polygon.

An aspect of this disclosure provides a non-transitory computer-readable storage medium storing instructions which when executed by a processor cause the processor to perform any of the methods of this disclosure.

The technical solutions provided in this disclosure can include the following beneficial effects:

In an example, the event sequence data set is represented by using a graphic (such as a map) formed by splicing a plurality of polygons, each of the polygons is configured for representing one event sequence, a user is supported to operate by aiming at one polygon in the graphic, the event sequence data corresponding to the polygon may be checked, an effect of showing a plurality of event sequences and corresponding event sequence data through one graphic is achieved, each event sequence only occupies a region where one polygon in the graphic is located, and the compactness is higher. Therefore, a space utilization rate of a display image required for event sequence display can be improved.

The foregoing general descriptions and the following detailed descriptions are merely for illustration and explanation purposes and are not intended to limit this disclosure.

### BRIEF DESCRIPTION OF THE DRAWINGS

FIG. 1 is a schematic diagram of an event sequence data display method provided by an aspect of this disclosure.

FIG. 2 is a schematic diagram of an implementation environment provided by an aspect of this disclosure.

FIG. 3 is a flow chart of an event sequence data display method provided by an aspect of this disclosure.

FIG. 4 is a schematic diagram of a map provided by an aspect of this disclosure.

FIG. 5 is a schematic diagram of a map provided by another aspect of this disclosure.

FIG. 6 is a schematic diagram of a map provided by another aspect of this disclosure.

FIG. 7 is a schematic diagram of a map provided by another aspect of this disclosure.

FIG. 8 is a schematic diagram of a map provided by another aspect of this disclosure.

FIG. 9 is a flow chart of an event sequence data display method provided by another aspect of this disclosure.

FIG. 10 is a schematic diagram of a tree structure provided by an aspect of this disclosure.

FIG. 11 is a schematic diagram of a tree structure provided by another aspect of this disclosure.

FIG. 12 is a schematic diagram of an event sequence data display method provided by another aspect of this disclosure.

FIG. 13 is a block diagram of an event sequence data display apparatus provided by an aspect of this disclosure.

FIG. 14 is a block diagram of an event sequence data display apparatus provided by another aspect of this disclosure.

FIG. 15 is a block diagram of a terminal device provided by an aspect of this disclosure.

### DETAILED DESCRIPTION

Example aspects are described in further detail herein, and examples of the aspects are shown in accompanying drawings. When the following description involves the accompanying drawings, unless otherwise indicated, the same numerals in different accompanying drawings represent the same or similar elements. The descriptions of the terms are provided as examples only and are not intended to limit the scope of the disclosure.

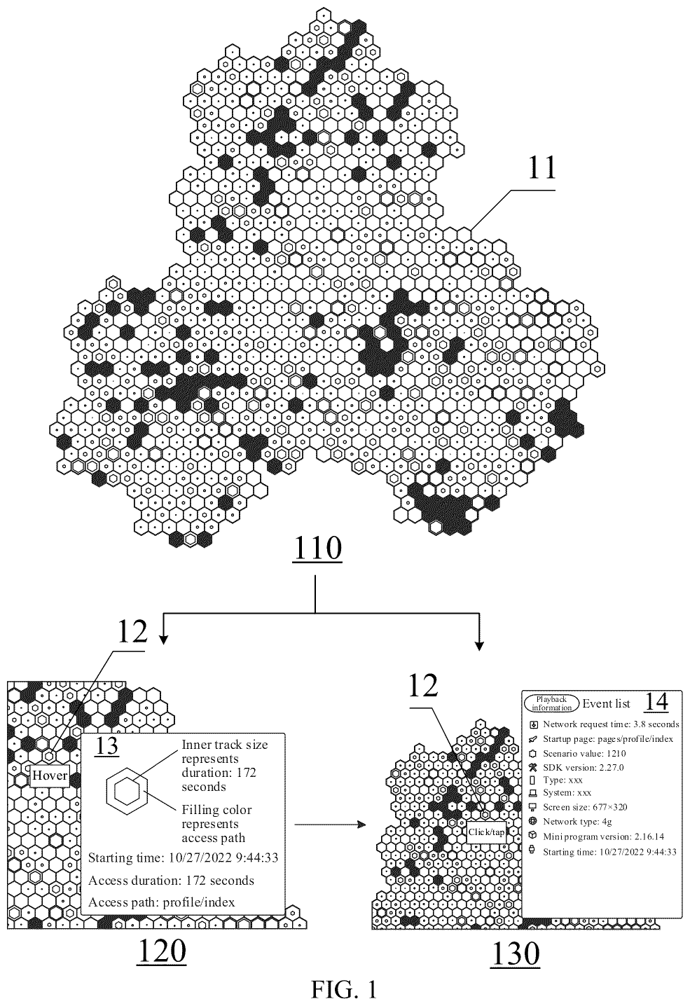

FIG. 1 is a schematic diagram of an event sequence data display method provided by an aspects of this disclosure. The method may include the following operations:

Operation 110: Display a graphic 11 corresponding to an event sequence data set.

The graphic 11 is formed by splicing a plurality of polygons, and each of the polygons corresponds to one piece of event sequence data in the event sequence data set. The polygons corresponding to the same event sequence data have a same color, and the polygons corresponding to different event sequence data have different colors.

Operation 120: Display basic information 13 of the event sequence data corresponding to a first polygon 12 in response to a hover operation (i.e., a cursor of a mouse hovers only on a first polygon 12) aiming at the first polygon 12 in the graphic 11.

Operation 130: Display detailed information 14 of the event sequence data corresponding to the first polygon 12 in response to a click/tap operation aiming at the first polygon 12 in the graphic 11.

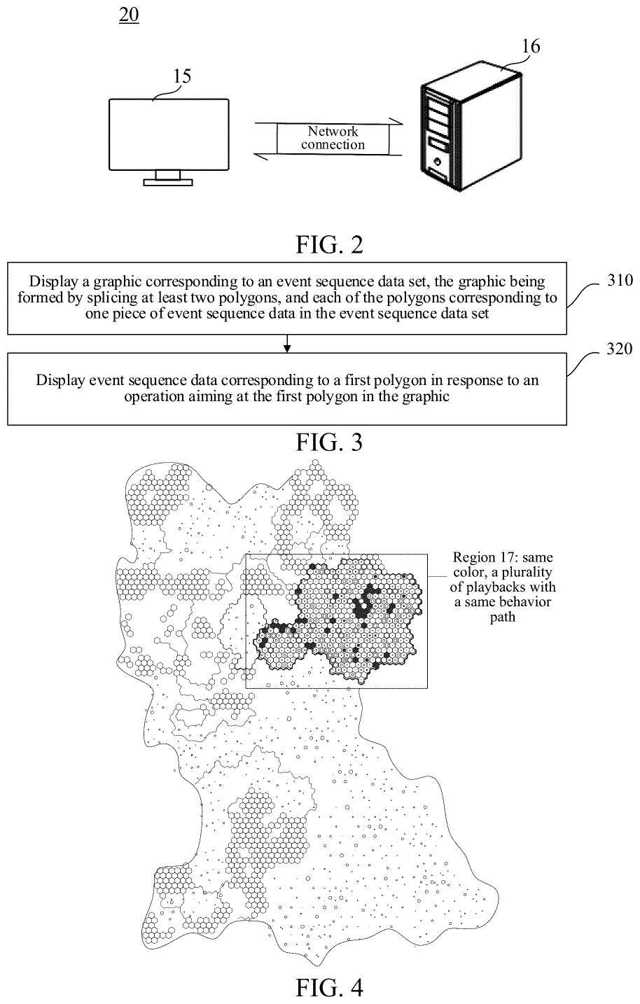

Referring to FIG. 2, FIG. 2 is a schematic diagram of an implementation environment provided by an aspect of this disclosure. The implementation environment may be implemented as a data analysis system. As shown in FIG. 2, the system 20 may include: a terminal device 15.

A target application, such as a client of the target application, is installed and runs in the terminal device 15. The terminal device is an electronic device having data calculation, processing, and storage capabilities. The terminal device may be a smartphone, a tablet computer, a personal computer (PC), a wearable device, etc. This is not limited in the aspects of this disclosure. The target application may further be a data analysis application, or any application having an event sequence data display function, such as a social application, a payment application, a video application, a music application, a shopping application, or a news application. In the method provided in the aspects of this disclosure, each operation may be performed by the terminal device 15, for example, the client running in the terminal device 15.

In some aspects, a user may generate the graphic corresponding to the event sequence data set through the above target application, and may check an analysis result, such as a user experience analysis result for a certain application, corresponding to the event sequence data set through the graphic. The user may further check a certain event sequence data in the event sequence data set through the graphic. This is not limited in aspects of this disclosure.

In some aspects, the system 20 further includes a server 16. The server 16 establishes a communication connection (such as a network connection) with the terminal device 15. The server 16 is configured to provide a backend service for the target application. The server may be an independent physical server, or may be a server cluster or a distributed system formed by a plurality of physical servers, or may be a cloud server providing cloud computing services. In some aspects, the graphic corresponding to the event sequence data set may be generated by the server 16, and displayed by the terminal device 15.

The technical solutions of this disclosure are described below by using several aspects.

Referring to FIG. 3, FIG. 3 is a flow chart of an event sequence data display method provided by an aspect of this disclosure. In this aspect, an example in which the method is applied to the client of the terminal device above is used for description. The method may include the following operations (Operation 310 to Operation 320).

Operation 310: Display a graphic corresponding to an event sequence data set, the graphic being formed by splicing at least two polygons, and each of the polygons corresponding to one piece of event sequence data in the event sequence data set. For example, a visual representation corresponding to an event sequence data set is displayed. The visual representation is formed by splicing a plurality of polygons. Each of the plurality of polygons corresponds to a respective piece of the event sequence data in the event sequence data set. The respective piece of the event sequence data indicates a sequence formed by events.

The above event sequence data set is a data set formed by several event sequence data. In some aspects, the event sequence data set includes a plurality of event sequence data, the event sequence data is configured for recording event sequences, and the event sequence refers to the sequence formed by one or more events. For example, the event sequence data may be the sequence data formed by a series of events with timestamps.

The event sequence data is not limited in aspects of this disclosure. In some aspects, the event sequence data may be a series of behavior sequences of a user in daily life, for example: getting up, eating breakfast, going to school and attending class; and for another example: going to office, driving home, making dinner, eating dinner, taking a bath and sleeping. In some aspects, the event sequence data may be sequences of a user to access a website or use an application or use the terminal device, for example: accessing a home page of a target website, executing a searching function of the target website, searching the target data through the searching function, and downloading a data file corresponding to the target data; for another example: opening the target application, entering a personal account management module, checking a nickname of a personal account, modifying the nickname, and quitting the target application; and for another example: starting a terminal device, opening and logging in to a mailbox application, opening a browser application, opening and logging in to an enterprise intranet site, and opening and logging in to a social application.

In some aspects, the events in the event sequence data may be sequenced in a time sequence. The same event sequence data may include different events, and may include repeated events. This is not limited in aspects of this disclosure.

Each event sequence data included in the event sequence data set may belong to a scope of the same region (city), same school, same application, etc. The event sequence data acquisition time is not limited in the aspect of this disclosure, and the data may be acquired in hours, days, weeks, etc. The event sequence data set acquisition period is not limited in the aspect of this disclosure. For example, the event sequence data corresponding to a certain application may be acquired in days within a week.

In some aspects, the same event sequence data refers to the same events corresponding to the event sequence data and the same sequence order between different events. Different event sequence data refers to different events corresponding to the event sequence data or different sequence orders between different events. The polygons corresponding to the same event sequence data have the same appearances, and the polygons corresponding to different event sequence data have different appearances. For example, for the first event sequence data: A, B, and C, the second event sequence data: A, B, and C, and the third event sequence data: A, C, and B, the first event sequence data and the second event sequence data are the same, the first event sequence data and the third event sequence data are different, the polygon corresponding to the first event sequence data and the polygon corresponding to the second event sequence data have the same appearance, and the polygon corresponding to the first event sequence data and the polygon corresponding to the third event sequence data have different appearances.

The above graphic is configured for showing the event sequence data set. For example, it may be configured for mass visual display of each event sequence data in the event sequence data set. The graphic is not limited in aspects of this disclosure. For example, the graphic may be a graphic similar to a map, and may be a map. The above graphic may be a graphic in a two-dimensional space, and each point in the graphic may be represented by two-dimensional coordinates.

For example, the plurality of event sequence data may be shown in a map form, the map is formed by splicing a plurality of polygons, and each of the polygons in the map represents one piece of event sequence data. Each event sequence data includes at least one event and the sequence order of the at least one event.

The above polygon may be configured for indicating a region defined by a plurality of edges, and the edges of the polygon are used as a boundary (contour) of the region. The quantity of the edges of the polygon, the shape of the polygon, etc. are not limited in aspects of this disclosure. In some aspects, the polygons in the map may be densely laid polygons, for example, regular triangles, regular quadrilaterals, regular pentagons, regular hexagons, isosceles right triangles, rectangles, parallelograms, isosceles trapezoids, isosceles triangles, right trapezoids, etc. The polygons may be densely laid, so that the space utilization rate of the display image may be favorably improved. In some aspects, the polygons are regular hexagons as shown in FIG. 1. Each regular hexagon may be spliced in a seamless mode to be densely laid, and the space waste is reduced.

In some aspects, the polygons corresponding to the same event sequence data have same appearances, and the polygons corresponding to different event sequence data have different appearances. The appearance of the polygons includes at least one of the followings: shape, color, size, and filling. In some aspects, each polygon in the graphic occupies the same region, for example, each polygon has the same shape and size. In such a mode, a user may favorably and fast distinguish which event sequence data is the same and which event sequence data is different, and the information obtaining efficiency and convenience are favorably improved.

For example, the descriptions that the polygons corresponding to the same event sequence data have the same appearances, and the polygons corresponding to different event sequence data have different appearances refer to: the polygons corresponding to the same event sequence data have a same color, and the polygons corresponding to different event sequence data have different colors. Different colors of the polygons may be red, pink, yellow, green, blue, purple, etc. In some aspects, different Red-Green-Blue (RGB) values of the colors of the polygons indicate that the polygons have different colors. The event sequence data is distinguished by colors in such a mode, a user may more easily distinguish the event sequence data, and the information obtaining efficiency and convenience are favorably improved.

For example, based on the above aspects, the polygon corresponding to the first event sequence data and the polygon corresponding to the second event sequence data have the same color, and the polygon corresponding to the first event sequence data and the polygon corresponding to the third event sequence data have different colors.

In some aspects, the judging condition of the same appearance of the polygons includes but is not limited to at least one of the followings: the polygons have the same color, the polygons have the same contour color, the polygons have the same line type of the edge line, and the polygons have the same brightness. Correspondingly, the judging condition of different appearances of the polygons includes but is not limited to at least one of the followings: the polygons have different colors, the polygons have different contour colors, the polygons have different line types of the edge lines, and the polygons have different brightnesses. The basic color of the polygons may refer to the color of a region of the polygons near the edge, and the contour color of the polygons refers to the color of the edge lines of the polygons.

In some aspects, the above graphic is divided into a plurality of blocks, each block includes at least one polygon, polygons included in different blocks correspond to different event sequence data, and a plurality of polygons included in the same block correspond to the same event sequence data. By taking a form of the graphic being a map as an example, the event sequence data corresponding to the polygons located in the same block in the map is the same. That is, the polygons included in the same block have the same respectively corresponding events and the same sequence order between events. In some aspects, the attribute parameters corresponding to the event sequence data corresponding to different polygons in the same block may be the same or may be different. The event sequence data corresponding to the polygons located in different blocks in the map is different. That is, the polygons located in different blocks have different respectively corresponding events or different sequence orders between events.

The polygons corresponding to the same event sequence data have the same appearance, and the polygons corresponding to different event sequence data have different appearances, so the polygons located in the same block have the same appearance, and the polygons located in different blocks have different appearances. Therefore, if the same event sequence data is divided to be in one block, a user may favorably and fast complete the event sequence data clustering, and the information obtaining efficiency and convenience may be favorably and further improved.

As shown in FIG. 4, the polygons in a block 17 have the same color, it shows that the event sequence data corresponding to the polygons in the block 17 is the same.

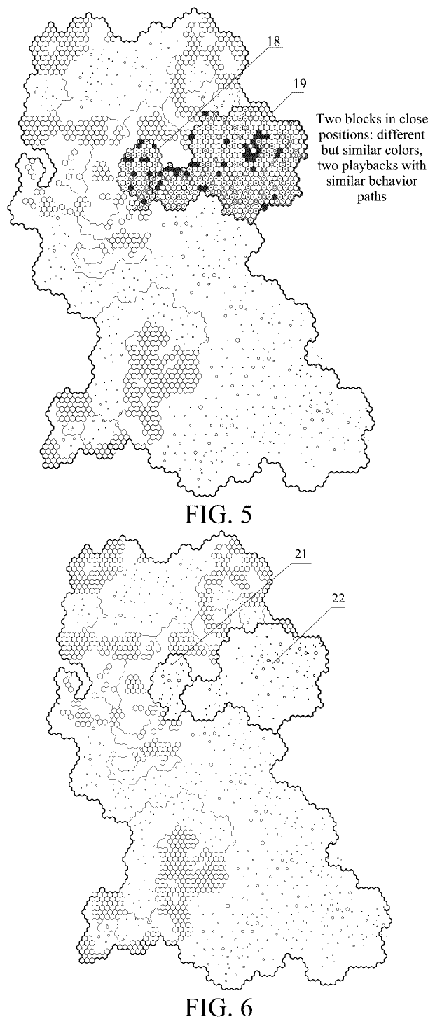

As shown in FIG. 5, a block 18 and a block 19 are different blocks, and have different colors. Therefore, the event sequence data corresponding to the polygons in the block 18 is different from the event sequence data corresponding to the polygons in the block 19. In some aspects, the colors of the polygons in adjacent or close blocks are similar, and the correspondingly represented event sequence data is similar. For example, the block 18 is adjacent to the block 19, it shows that the event sequence data corresponding to the polygons in the block 18 is similar to the event sequence data corresponding to the polygons in the block 19. For example, there are only tiny differences in included events and the sequence order of the events. Therefore, the colors of the polygons in the block 18 may be set to be similar to the colors of the polygons in the block 19 to show that the event sequence data corresponding to the polygons in the block 18 is similar to the event sequence data corresponding to the polygons in the block 19. The polygons corresponding to the similar event sequence data are set into adjacent blocks, and the analysis efficiency of the event sequence data set is favorably improved, so that a user may fast know the difference and similarity between the event sequence data.

In some aspects, each block has an edge contour, and different blocks are distinguished through edge contours. Therefore, a user may favorably and fast obtain different blocks, and the information obtaining efficiency and convenience may be favorably and further improved. In some aspects, the edge contour between different blocks is different from the edge contour between different polygons in the same block. For example, the edge contour between different blocks is black, and the edge contour between different polygons in the same block is white. For another example, the edge contour between different blocks is a full line, and the edge contour between different polygons in the same block is a dotted line.

As shown in FIG. 6, a block 21 and a block 22 are two close but different blocks, the block 21 and the block 22 are distinguished by a black full line in a junction. There is no black full line at the junction of different polygons in the same block (such as the block 21 or the block 22).

In some aspects, attribute marks are displayed inside the polygons, and are configured for showing attribute parameters of the event sequence data corresponding to the polygons. The attribute parameters may include at least one of the starting time, ending time, duration, and event occurrence place of the corresponding event sequence data. In some aspects, one polygon may have one or more attribute marks.

In some aspects, different attribute marks are configured for showing different attribute parameters. For example, the attribute mark corresponding to the starting time is configured for showing the starting time of the event sequence data, and the attribute mark corresponding to the duration is configured for showing the duration of the event sequence data. Therefore, a user may favorably and visually know different attribute parameters of the event sequence data and the differences between different event sequence data.

In some aspects, the attribute marks in different sizes are configured for showing attribute parameters with different values. For example, the attribute marks in different polygons represent parameters of the same attribute type, and the attribute marks in different sizes correspond to different attribute parameter values. In some aspects, the greater the attribute mark size, the greater the attribute parameter value; and the smaller the attribute mark size, the smaller the attribute parameter value. In some aspects, the attribute marks in different polygons are configured for showing the duration or access duration of a series of events in the corresponding event sequence data. The greater the attribute mark size, the longer the corresponding duration; and the smaller the attribute mark size, the shorter the corresponding duration. In some aspects, the attribute marks in the same size represent the same duration or access duration of a series of events in the corresponding event sequence data.

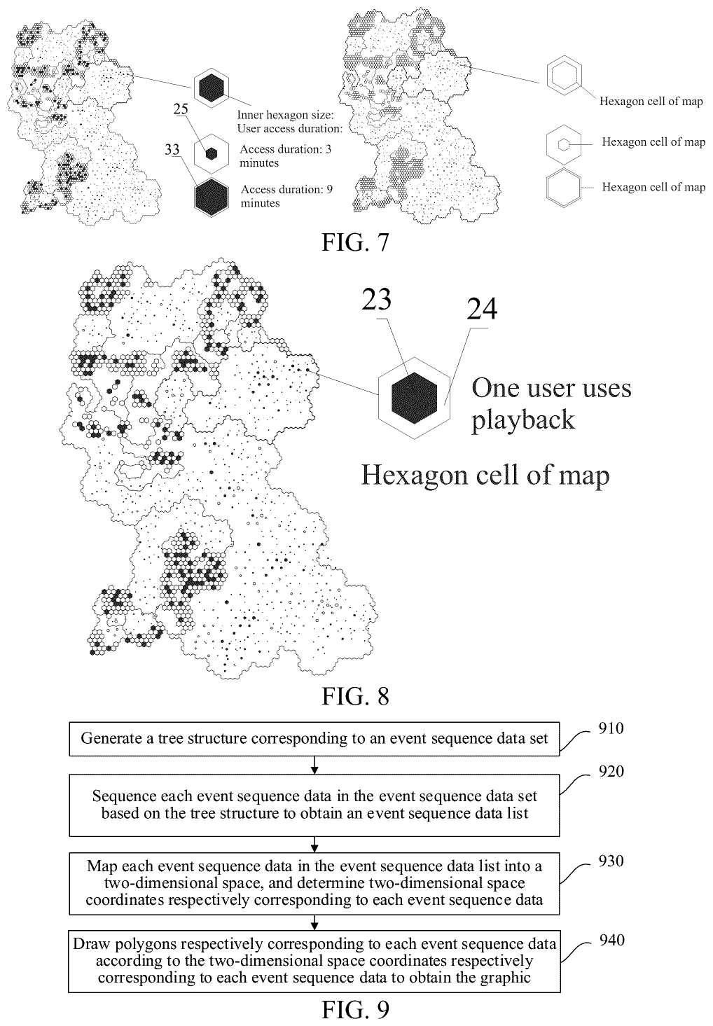

For example, as shown in FIG. 7, the attribute marks are configured for showing the access duration of a user corresponding to the event sequence data aiming at a certain website, the polygons are hexagons, the attribute marks are hexagons restrained by the contours of the polygons, and the attribute mark and the polygon share the same center point. The size of the hexagons corresponding to the attribute marks is positively correlated with the access duration. For example, the size of the attribute mark 25 corresponding to the event sequence data with the access duration being 3 minutes is smaller than the size of the attribute mark 33 corresponding to the event sequence data with the access duration being 9 minutes. The value of the attribute parameter is visually shown through the size of the attribute mark, so a user may conveniently know the value of the attribute parameter and know the whole of the values of the attribute parameters of each corresponding event sequence data in the whole block, and the user may visually know the attribute parameters of a single event sequence data and the integral attribute of the event sequence data set, so the information obtaining efficiency and convenience are improved.

In some aspects, the attribute mark may have the same shape as the above polygon, and the size may be smaller than that of the above polygon mark of the polygon. In some aspects, the color of the attribute mark is different from the color of the corresponding polygon (the color of the polygon may be considered to be the background color of the polygon). For example, as shown in FIG. 8, the color of the attribute mark 23 is darker than the color of the corresponding polygon 24, and the size of the attribute mark 23 is smaller than the size of the corresponding polygon 24. In some aspects, each polygon (hexagon cell as shown in FIG. 7) represents once event sequence data corresponding to one user, and a plurality of event sequence data corresponding to the user may exist at the same time in the event sequence data set.

In some aspects, a client may show the event sequence data set in different display patterns, so that the user may switch the event sequence data set display patterns according to own needs. For example, the client firstly shows each event sequence data in the event sequence data set in a list form. In response to a display pattern switching operation, the client displays a graphic corresponding to the event sequence data set. The display pattern switching operation refers to an operation of the user to switch the display pattern. For example, it may be a triggering operation aiming at a pattern switching control, such as click/tap, press, and sliding.

For example, each event sequence data in the event sequence data set is shown in a list form at the beginning, the user may switch the display pattern from the list form to a map form through the display pattern switching operation, so that the event sequence data set may be displayed. That is, the event sequence data set may be displayed in various display forms, so that the display forms of the event sequence data are enriched. Additionally, the user may select and switch the display form of the event sequence data set, so that the user may know the event sequence data possibly in the own willing, and the user experience is improved.

Operation 320: Display event sequence data corresponding to a first polygon in response to an operation aiming at the first polygon in the graphic. For example, when an operation is performed on a first polygon in the visual representation, the event sequence data corresponding to the first polygon is displayed.

The first polygon may be any one polygon in the graphic, and may also be called as a target polygon. The event sequence data in the aspects of this disclosure includes content information of the event sequence. The content information includes basic information and detailed information of the event sequence. The basic information may include a name, a starting time, a duration, an access path, etc. The detailed information may include: an analysis result, events included in the event sequence, etc. In some aspects, the corresponding information amount of the detailed information is greater than the information amount of the basic information.

In some aspects, the polygon in the graphic may show the general condition of the whole of the event sequence data set. If the user wants to know a specific event sequence data, the content information of the event sequence data may be checked through the operation aiming at the polygon corresponding to the event sequence data.

In some aspects, different operations aiming at the first polygon correspond to different displayed content information. For example, in response to the first operation aiming at the first polygon, the basic information of the event sequence data corresponding to the first polygon is displayed; and in response to the second operation aiming at the first polygon, the detailed information of the event sequence data corresponding to the first polygon is displayed.

The above first operation and the second operation are different operation modes. For example, the first operation is the operation of an operator hovering on the first polygon, and the second operation is the operation of performing clicking/tapping (for example, single-clicking/single-tapping, or double-clicking/double-tapping) on the first polygon. For another example, the first operation is the operation of the operator performing single-clicking/single-tapping on the first polygon, and the second operation is the operation of performing double-clicking/double-tapping on the first polygon. For another example, the first operation is the operation of the operator clicking/tapping the first polygon, and the second operation is the operation of performing long press on the first polygon. In some aspects, the operator may be a cursor of the mouse, may be a touch control apparatus (such as a touch control pen, or a touch control ball), and may further be a body part of the user such as a finger or a palm.

It is clear that the above are only examples of the first operation and the second operation, the first operation and the second operation may be in other operation forms, and this is not specifically limited in aspects of this disclosure.

In some aspects, the basic information and the detailed information may include different information. In some aspects, the information amount of the detailed information is greater than the information amount of the basic information. For example, as shown in FIG. 1, the information included in the detailed information 14 is more detailed and concrete than that included in the basic information 13.

In aspects of this disclosure, different content information is displayed through different operations, and the layered display on the content information is achieved. For a certain polygon, the user may select to execute the first operation or the second operation or skip to execute any operation to know the required content information or to skip to know the content information of the corresponding event sequence data according to the own needs, so that the operation flexibility is improved.

Based on the above, in the technical solutions provided by aspects of this disclosure, the event sequence data set is represented by using a graphic (such as a map) formed by splicing a plurality of polygons, each of the polygons is configured for representing one event sequence, a user is supported to operate by aiming at one polygon in the graphic, the event sequence data corresponding to the polygon may be checked, an effect of showing a plurality of event sequences and corresponding event sequence data through one graphic is achieved, each event sequence only occupies a region where one polygon in the graphic is located, and the compactness is higher. Therefore, a space utilization rate of a display image required for event sequence display is improved.

Referring to FIG. 9, FIG. 9 is a flowchart of an event sequence data display method provided by another aspect of this disclosure. In this aspect, an example in which the method is applied to the client of the terminal device above is used for description. The method may include the following operations (910 to 940).

Operation 910: Generate a tree structure corresponding to an event sequence data set. For example, a tree structure corresponding to the event sequence data set is generated.

The tree structure is a one-layer nested structure. The tree structure in the aspects of this disclosure is a tree structure using events as nodes and using event occurrence sequence order as edges. For example, the tree structure corresponding to the event sequence data set is constructed and obtained based on the events corresponding to each event sequence data in the event sequence data set and the event occurrence sequence order. The event sequence data set is the same as the above descriptions of the aspects, and it is not repeated herein.

In some aspects, each node except for a root node in the tree structure corresponds to one event, each node except for the root node in the tree structure has a corresponding event sequence data group, and an event sequence data group corresponding to a first node in the tree structure includes: at least one piece of event sequence data regarding an event corresponding to the first node as a last event.

The event sequence data group is a group formed by the event sequence data with the same last events. The first node is any one node except for the root node.

In some aspects, the tree structure marks the events included in the event sequence data and the sequence order between events through a plurality of nodes and directed connection lines among the plurality of nodes. In each event sequence data, the occurrence time of the event corresponding to the node closer to the root node is earlier, and the sequence order in the event sequence data is near the front; and the occurrence time of the event corresponding to the node farther to the root node is later, and the sequence order in the event sequence data is near the back.

In some aspects, the operation 910 further includes the following operations (1.1 to 1.4, not shown in the figures).

1.1: Generate the root node of the tree structure.

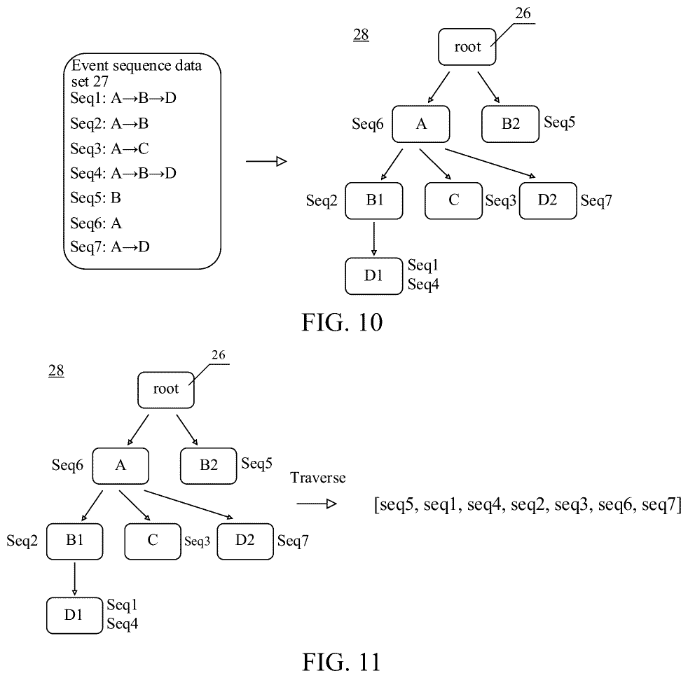

In some aspects, for an event sequence data set, its corresponding tree structure only has one root node. As shown in FIG. 10, the root node 26 may be represented as root. The root node has no entering edge, and also has no father node.

1.2: Traverse each event sequence data in an event sequence data set, and determine the root node as a current node.

In some aspects, during traversal of each event sequence data, the root node is used as the current node at the beginning. That is, for any one event sequence data, the root node is used as the current node, the event corresponding to the event sequence data is traversed, and the construction of the node and edge corresponding to the event sequence data is performed.

1.3: Traverse each event in the event sequence data according to an occurrence sequence order of each event in the event sequence data, determine a node corresponding to the event as the current node in a case that the node corresponding to the event exists in child nodes of the current node, and search a next event in the event sequence data until all events in the event sequence data are traversed; and add the node corresponding to the event in the child nodes of the current node in a case that no node corresponding to the event exists in the child nodes of the current node, determine the node corresponding to the event as the current node, and search a next event in the event sequence data until all events in the event sequence data are traversed.

In some aspects, the child node of a certain node refers to a next-layer node of the node in the path trend of the tree structure. There is only one directed edge (the direction of the edge is pointed to the child node from the node) corresponding to the path between the child node of a certain node and the node, and there are no other nodes between the child node of a certain node and the node.

In some aspects, if a child node corresponding to an m^{th} event in the event sequence data exists in the child node of the current node, the child node is determined as the current node (i.e., the current node is updated into the child node), the child node is the node corresponding to the m^{th} event in the event sequence data, and the m is a positive integer. In some aspects, if no child node corresponding to an m^{th} event in the event sequence data exists in the child node of the current node, the node corresponding to the m^{th} event in the event sequence data is added as one child node of the current node, then, the node corresponding to the m^{th} event in the event sequence data is determined as the current node (i.e., the current node is updated into the node corresponding to the m^{th} event in the event sequence data). In some aspects, after every updating of the current node, a next event (for example, a (m+1)^{th} event in the event sequence data) in the event sequence data is continuously searched until all events in the event sequence data are traversed.

For example, if the root node is used as the current node, and the child node corresponding to the first event in the event sequence data exists in the child node of the root node, the child node is determined as the current node, and the child node is the node corresponding to the first event in the event sequence data. If no child node corresponding to the first event in the event sequence data exists in the child node of the root node, the node corresponding to the first event is added as one child node of the root node, and then, the node (i.e., the child node) corresponding to the first event is determined as the current node. Then, a second event in the event sequence data is continuously searched in the above mode until all events in the event sequence data are traversed.

For example, as shown in FIG. 10, the event sequence data set 27 includes 7 event sequence data, respectively including:
event sequence data 1 (Seq1, for short): A→B→D
event sequence data 2 (Seq2, for short): A→B
event sequence data 3 (Seq3, for short): A→C
event sequence data 4 (Seq4, for short): A→B→D
event sequence data 5 (Seq5, for short): B
event sequence data 6 (Seq6, for short): A
event sequence data 7 (Seq7, for short): A→D

As shown in FIG. 10, after the root node 26 of the tree structure is generated, the following operations are performed on Seq1 (A→B→D):
when the event A in Seq1 is traversed, the root node 26 is firstly used as the current node, the root node 26 has no child node at present, the node corresponding to the event A in Seq1 is added to be used as a child node of the root node 26, i.e., the node A, and the node A is determined as the current node.

When the event B in Seq1 is traversed, the node A has no child node at present, the node corresponding to the event B in Seq1 is added to be used as a child node of the node A, i.e., the node B1, and the node B1 is determined as the current node.

When the event D in Seq1 is traversed, the node B1 has no child node at present, the node corresponding to the event D in Seq1 is added to be used as a child node of the node B1, i.e., the node D1, and the node D1 is determined as the current node.

So far, all events in Seq1 are traversed, and the tree structure part corresponding to Seq1 is root node→node A→node B1→node D1.

The following operations are performed on Seq2 (A→B):

When the event A in Seq2 is traversed, the root node 26 is firstly used as the current node, the child node corresponding to the event A, i.e., the node A exists in the child node of the root node 26, and the node A is determined as the current node.

When the event B in Seq2 is traversed, the child node corresponding to the event B, i.e., the node B1 exists in the child node of the node A, and the node B1 is determined as the current node.

So far, all events in Seq2 are traversed, and the tree structure part corresponding to Seq2 is root node→node A→node B1.

The following operations are performed on Seq3 (A→C):

When the event A in Seq3 is traversed, the root node 26 is firstly used as the current node, the child node corresponding to the event A, i.e., the node A exists in the child node of the root node 26, and the node A is determined as the current node.

When the event C in Seq3 is traversed, no node corresponding to the event C exists in the child node of the node A at present, the node corresponding to the event C in Seq3 is added to be used as a child node of the node A, i.e., the node C, and the node C is determined as the current node.

So far, all events in Seq3 are traversed, and the tree structure part corresponding to Seq3 is root node→node A→node C.

The following operations are performed on Seq4 (A→B→D):

When the event A in Seq4 is traversed, the root node 26 is firstly used as the current node, the child node corresponding to the event A, i.e., the node A exists in the child node of the root node 26, and the node A is determined as the current node.

When the event B in Seq4 is traversed, the child node corresponding to the event B, i.e., the node B1 exists in the child node of the node A, and the node B1 is determined as the current node.

When the event D in Seq4 is traversed, the child node corresponding to the event D, i.e., the node D1 exists in the child node of the node B1, and the node DI is determined as the current node.

So far, all events in Seq4 are traversed, and the tree structure part corresponding to Seq4 is root node→node A→node B1→node D1.

The following operations are performed on Seq5 (B):

When the event B in Seq5 is traversed, no node corresponding to the event B exists in the child node of the root node 26 at present, the node corresponding to the event B in Seq5 is added as a child node of the root node 26, i.e., the node B2, and the node B2 is determined as the current node.

So far, all events in Seq5 are traversed, and the tree structure part corresponding to Seq5 is root node→node B2.

The following operations are performed on Seq6 (A):

When the event A in Seq6 is traversed, the root node 26 is firstly used as the current node, the child node corresponding to the event A, i.e., the node A exists in the child node of the root node 26, and the node A is determined as the current node.

So far, all events in Seq6 are traversed, and the tree structure part corresponding to Seq6 is root node→node A.

The following operations are performed on Seq7 (A→D):

When the event A in Seq7 is traversed, the root node 26 is firstly used as the current node, the child node corresponding to the event A, i.e., the node A exists in the child node of the root node 26, and the node A is determined as the current node.

When the event D in Seq7 is traversed, no node corresponding to the event D exists in the child node of the node A at present, the node corresponding to the event D in Seq7 is added to be used as a child node of the node A, i.e., the node D2, and the node D2 is determined as the current node.

So far, all events in Seq7 are traversed, and the tree structure part corresponding to Seq7 is root node→node A→node D2.

1.4: Construct and obtain the tree structure corresponding to the event sequence data set after the traversal of all event sequence data in the event sequence data set is finished.

In some aspects, as shown in FIG. 10, after the traversal of all event sequence data in the event sequence data set 27 is finished, the tree structure 28 corresponding to the event sequence data set 27 is obtained. The event sequence data set is converted into the tree structure, so that the correlation between the event sequence data is clearer, and the correlation between the time in the event sequence data is clearer, so that the generation accuracy of the graphic is favorably improved.

Operation 920: Sequence each event sequence data in the event sequence data set based on the tree structure to obtain an event sequence data list. For example, each piece of the event sequence data in the event sequence data set is sequenced based on the tree structure to obtain an ordered event sequence data list.

The above event sequence data list is a list formed by event sequence data distributed in sequence. In some aspects, each event sequence data in the event sequence data set needs to be sequenced, so that the same event sequence data is similarly ranged, the similar event sequence data is similarly ranged, then, the graphic is constructed based on the event sequence data list, the display effect of the graphic is favorably improved, and the information obtaining convenience is further improved.

In some aspects, the operation 920 includes the following sub operations (2.1 to 2.8).

2.1: Traverse each node in the tree structure from the root node of the tree structure.

2.2: Initialize the root node into a first node, the first node also being called as the target node.

2.3: Sequence each child node of the first node in a depth ascending order to obtain a child node sequence of the first node, a depth of the child nodes referring to a layer number of descendant nodes included in the child nodes.

2.4: Resequence the first node and each child node in the child node sequence of the first node to obtain the node sequence corresponding to the first node.

2.5: Determine the node sequence corresponding to the first node as a complete node sequence.

2.6: Determine the first child node as the first node to obtain the node sequence corresponding to the first node if a first child node of the first node has descendant nodes, and replace the first node in the complete node sequence by the node sequence corresponding to the first node to obtain an updated complete node sequence, the first child node also being called as the target child node.

2.7: Determine a last updated complete node sequence as a final complete node sequence after the traversal of all nodes in the tree structure is finished.

2.8: Sequence the event sequence data included in the event sequence data group corresponding to each of the nodes according to the sequence of each node included in the final complete node sequence to obtain the event sequence data list.

In some aspects, the event sequence data corresponding to the node of the last event in each event sequence data is grouped to determine the event sequence data group where the event sequence data is located. As shown in FIG. 11, the node corresponding to the last event corresponding to Seq1 (i.e., the event D in Seq1) is the node D1, and the Seq1 belongs to the event sequence data group corresponding to the node D1.

In some aspects, the operations that the first node and each child node in the child node sequence of the first node are resequenced to obtain the node sequence corresponding to the first node include the following sub operations (2.4.1 to 2.4.2):

2.4.1: Orderly sequence the child node of the first node and the first node to obtain the node sequence corresponding to the first node if a quantity of the child nodes of the first node is 1.

2.4.2: Split the child node sequence of the first node into a first subsequence and a second subsequence according to an index of the child node if the quantity of the child nodes of the first node is greater than 1, the first subsequence including child nodes with odd number indexes, and the second subsequence including child nodes with even number indexes; and each child node in the first subsequence in an inverted sequence, the first node, and each child node in the second subsequence in an ordered sequence being orderly sequenced to obtain the node sequence corresponding to the first node.

In some aspects, as shown in FIG. 11, the operations of sequencing all event sequence data Seq1 to Seq7 corresponding to the tree structure 28 are as follows (3.1 to 3.10):

3.1: Use the root node 26 as an initialized first node.

3.2: Sequence the child nodes (i.e., the node A and the node B2) of the first node (i.e., the root node 26) in a depth ascending order.

The depth of the node A is 2, and the depth of the node B2 is 0, so that the child node sequence (may also be called as children_root) of the root node 26 is: node B2→node A.

3.3: Resequence the root node 26, the node A and the node B2.

The operation that the root node 26, the node A and the node B2 are resequenced includes the following sub operations (3.3.1 to 3.3.2):

3.3.1: Split the child nodes (the node A and the node B2) of the root node 26 into the first subsequence and the second subsequence according to the index of the child node due to the quantity of the child nodes of the root node 26 is greater than 1 (the quantity of the child nodes of the root node 26 is 2).

The index of the child node is the sequence order of the child nodes in the child node sequence of the root node 26. The index of the node A is 2, the index of the node B2 is 1, the child node with the odd index is determined as the first subsequence, the child node with the even index is determined as the second subsequence, the first subsequence of the root node 26 includes the node B2, and the second subsequence includes the node A.

3.3.2: Orderly sequenced each child node (i.e., the node A) in the first subsequence in an inverted sequence, the first node (i.e., the root node 26), and each child node (i.e., the node B2) in the second subsequence in an ordered sequence to obtain the node sequence corresponding to the root node 26: node B2→root node→node A.

3.4: Determine the current complete node sequence as: node B2→root node→node A.

3.5: Determine the node A as the first node, and determine the node sequence corresponding to the node A due to the child node A of the root node 26 has descendant nodes. The following sub operations (3.5.1 to 3.5.2) may be included:

3.5.1: Resequence the child nodes (i.e., the nodes B1, C, and D2) corresponding to the node A.

The depth of the node B1 is 1, and the depth of the node C and the depth of the node D2 are 0, so that the nodes B1, C, and D2 are resequenced according to the depth to obtain the child node sequence of the node A: node C→node D2→node B1.

3.5.2: Resequence the nodes A, B1, C, and D2 to obtain the node sequence corresponding to the node A.

In the above mode in 3.3.1, based on the child node sequence of the node A: node C→node D2→B1, the nodes B1, C, and D2 are split into the first subsequence of the node A: node B1→node C (the nodes in the same subsequence are also sequenced in a depth ascending order) and the second subsequence node of the node A: node D2. Then, according to the above sequencing mode as shown in 3.3.2, each child node (i.e., the nodes C and B1) in the first subsequence in an inverted sequence, the first node (i.e., the node A), and each child node (i.e., the node D2) in the second subsequence in an ordered sequence are orderly sequenced to obtain the node sequence corresponding to the node A: node B1→node C→node A→node D2.

3.6: Replace the node A in the above complete sequence by the node sequence corresponding to the node A to obtain the updated complete sequence: node B2→root node→node B1→node C→node A→node D2.

3.7: Due to the node B1 in the child node of the node A further has a child node (i.e., node D1), the node D1 belongs to the first subsequence of the node B1, and the node sequence corresponding to the node B1 is: node D1→node B1.

3.8: Replace the node B1 in the current complete sequence by the node sequence corresponding to the node B1 to obtain the updated complete sequence: node B2→root node→node D1→node B1→node C→node A→node D2.

3.9: The node B1 has no child node, and the final complete node sequence is: node B2→root node→node D1→node B1→node C→node A→node D2.

3.10: Sequence the event sequence data included in the event sequence data group corresponding to each of the nodes according to the sequence of each node included in the final complete node sequence to obtain the event sequence data list: Seq5, Seq1, Seq4, Seq2, Seq3, Seq6, and Seq7.

Operation 930: Map each event sequence data in the event sequence data list into a two-dimensional space, and determine two-dimensional space coordinates respectively corresponding to each event sequence data. For example, each piece of the event sequence data in the ordered event sequence data list is mapped into a two-dimensional space to determine two- dimensional space coordinates for each piece of the event sequence data.

In some aspects, the two-dimensional space is a two-dimensional space corresponding to the graphic. The two-dimensional space coordinates are used for indicating the position of the event sequence data in the graphic.

In some aspects, each event sequence data is mapped into the two-dimensional space where the map is located according to the sequence in the event sequence data list, and the two-dimensional space coordinates respectively corresponding to each event sequence data are obtained.

In some aspects, a big polygon is firstly generated, and then, the quantity of small polygons (i.e., polygons on the above map) obtained by diving the big polygon is determined according to the quantity of the event sequence data in the event sequence data list. A plurality of small polygons form an initial map. By taking the polygons being right triangles as an example, one right triangle may be divided into 4 smaller right triangles, if the size of each small right triangle needs to be identical, the quantity of the small triangles obtained by dividing the big triangle shall be exponential times of 4, for example, 4, 16, 64, etc. It is clear that the quantity of the small triangles obtained by dividing the big triangle needs to be greater than or equal to the quantity of the event sequence data. For example, if the quantity of the event sequence data is 7, the quantity of the small triangles obtained by dividing the big triangle is at least 16. If the quantity of the event sequence data is 18, 16 small triangles are not enough, and the quantity of the small triangles obtained by dividing the big triangle is at least 64.

In some aspects, the k polygons are densely laid and ranged to obtain an initial map. The k may be the quantity of the event sequence data included in the event sequence data list.

In some aspects, the operation 930 includes the following operations (4.1 to 4.2):

4.1: Generate a two-dimensional space coordinate array in a length k based on a Gosper curve generation algorithm, the k being greater than or equal to a quantity N of the event sequence data included in the event sequence data list, and the k and the N being both positive integers.

4.2: For i^{th} event sequence data in the event sequence data list, select a [i+(N−k)/2]^{th} two-dimensional space coordinate from the two-dimensional space coordinate array in the length k as a two-dimensional space coordinate corresponding to the i^{th} event sequence data, the i being a positive integer smaller than or equal to the N.

In some aspects, the k equals to the quantity of the small polygons obtained by dividing the big polygon. A plurality of small polygons are coded in a sequence from left to right and from top to bottom, and the coordinate of the polygon at the left upper corner is the first two- dimensional space coordinate in the k two-dimensional space coordinate arrays. [i+(N−k)/2] is a value obtained by leaving an integer part of a calculation result of i+(N−k)/2.

In an example, the quantity of the event sequence data is N being 7, and the k is 16. If the i is 1, [i+(N−k)/2]=[1+(16−7)/2]=5, and the two-dimensional space coordinate corresponding to the 1st event sequence data is the 5^{th} two-dimensional space coordinate in the two-dimensional space coordinate array. If the i is 2, [i+(N−k)/2]=[1+(16−7)/2]=6, and the two-dimensional space coordinate corresponding to the 2nd event sequence data is the 6th two-dimensional space coordinate in the two-dimensional space coordinate array. Through sequential calculation, the following may be obtained: the two-dimensional space coordinates corresponding to the 3^{rd}, 4^{th}, 5^{th}, 6^{th}, and 7^{th} event sequence data are respectively the 7^{th}, 8^{th}, 9^{th}, 10^{th}, and 11^{th} two-dimensional space coordinates in the two-dimensional space coordinate array.

Therefore, the two-dimensional space coordinates of the polygons corresponding to the adjacent event sequence data in the event sequence data list are adjacent, and the polygons corresponding to the adjacent event sequence data are possibly adjacent polygons. The events included in the adjacent event sequence data and the sequences between the events are similar, so that the polygons corresponding to the similar event sequence data are possibly similar by using the above implementations, and the integral harmony of the map is improved.

Operation 940: Draw polygons respectively corresponding to each event sequence data according to the two-dimensional space coordinates respectively corresponding to each event sequence data to obtain the graphic. For example, the visual representation with the polygons corresponding to each piece of the event sequence data is displayed based on the determined two-dimensional space coordinates.

In some aspects, the polygons respectively corresponding to each event sequence data is determined after the two-dimensional space coordinates respectively corresponding to each event sequence data is determined. The polygons corresponding to the same event sequence data are filled with the same color, corresponding attribute marks of the event sequence data are added and generated in each polygon, the polygons respectively corresponding to different event sequence data are respectively divided into different blocks through contours, the polygons corresponding to the same event sequence data are included in the blocks defined by the same contour, and the graphic corresponding to the event sequence data set may be obtained.

In some aspects, after the polygons respectively corresponding to each event sequence data are determined, the excessive polygons (polygons corresponding to no event sequence data) are removed, so that the graphic layout is simplified.

In some aspects, the polygons corresponding to similar but different event sequence data have similar colors. For example, colors of the polygons corresponding to two similar but different event sequence data may be respectively yellow green and light green.

Based on the above, according to the technical solutions provided by aspects of this disclosure, the tree structure corresponding to the event sequence data set is generated, the event sequence data in the event sequence data set is sequenced based on the tree structure, the similar event sequence data is ranged in close positions to obtain the event sequence data list, and then, the two-dimensional space coordinates of each event sequence data is determined based on the sequence order of each event sequence data in the list. The graphic (such as the map) is generated on the basis, so that the similar event sequence data possibly corresponds to the polygons in close positions in the graphic, a progressive and gradually changed ranging effect is achieved by the event sequence data corresponding to the polygons distributed in the graphic, and the conclusiveness and uniformity of the graphic are improved.

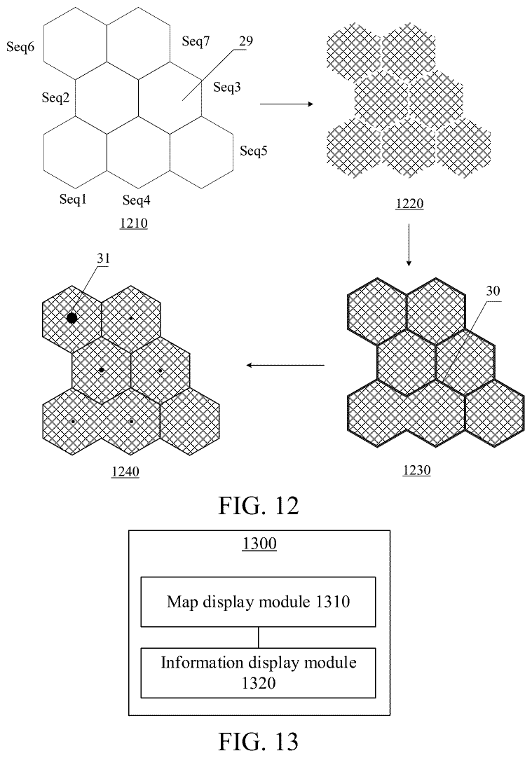

In some aspects, as shown in FIG. 12, the event sequence data display method may include the following operations:

Operation 1210: Firstly, determine the two-dimensional space coordinates respectively corresponding to each of the event sequence data to obtain hexagons 29 corresponding to each event sequence data.

Operation 1220: Fill the hexagons corresponding to same event sequence data with a same color, and fill the hexagons corresponding to different event sequence data with different colors.

Operation 1230: Draw contour boundaries 30 of each block.

Operation 1240: Add attribute marks 31 into each hexagon, and use the size of the attribute marks for showing the access duration to generate the graphic corresponding to the event sequence data set.

The following describes apparatus aspects of this disclosure, which can be used for executing the method aspects of this disclosure. For details not disclosed in the apparatus aspects of this disclosure, refer to the method aspects of this disclosure.

Referring to FIG. 13, FIG. 13 is a block diagram of an event sequence data display apparatus provided by an aspect of this disclosure. The apparatus has a function of implementing the foregoing event sequence data display method, and the function may be implemented by hardware or may be implemented by hardware executing corresponding software. The apparatus may be the terminal device described above, or may be disposed on the terminal device. The apparatus 1300 may include: a map display module 1310 and an information display module 1320.

The map display module 1310 is configured to display a graphic corresponding to an event sequence data set, the graphic is formed by splicing at least two polygons, each of the polygons corresponds to one piece of event sequence data in the event sequence data set, and the event sequence data is configured for recording a sequence formed by events.

The information display module 1320 is configured to display event sequence data corresponding to the first polygon in response to an operation aiming at the first polygon in the graphic.

In some aspects, the graphic is divided into a plurality of blocks, each block includes at least one polygon, polygons included in different blocks correspond to different event sequence data, and a plurality of polygons included in a same block correspond to same event sequence data.

In some aspects, each block has an edge contour, and different blocks are distinguished through edge contours.

In some aspects, the polygons corresponding to the same event sequence data have same appearances, and the polygons corresponding to different event sequence data have different appearances.

In some aspects, the polygons corresponding to the same event sequence data have a same color, and the polygons corresponding to different event sequence data have different colors.

In some aspects, attribute marks are displayed inside the polygons, and are configured for showing attribute parameters of the event sequence data corresponding to the polygons.

In some aspects, different attribute marks are configured for showing different attribute parameters.

In some aspects, the attribute marks in different sizes are configured for showing attribute parameters with different values.

In some aspects, the information display module 1320 is configured to:
in response to a first operation aiming at the first polygon, display basic information of the event sequence data corresponding to the first polygon;
or in response to a second operation aiming at the first polygon, display detailed information of the event sequence data corresponding to the first polygon.

In some aspects, the map display module 1310 is configured to:
display each of the event sequence data in the event sequence data set in a list form; and
in response to a display pattern switching operation, display a graphic corresponding to the event sequence data set.

In some aspects, the polygon is a regular hexagon.

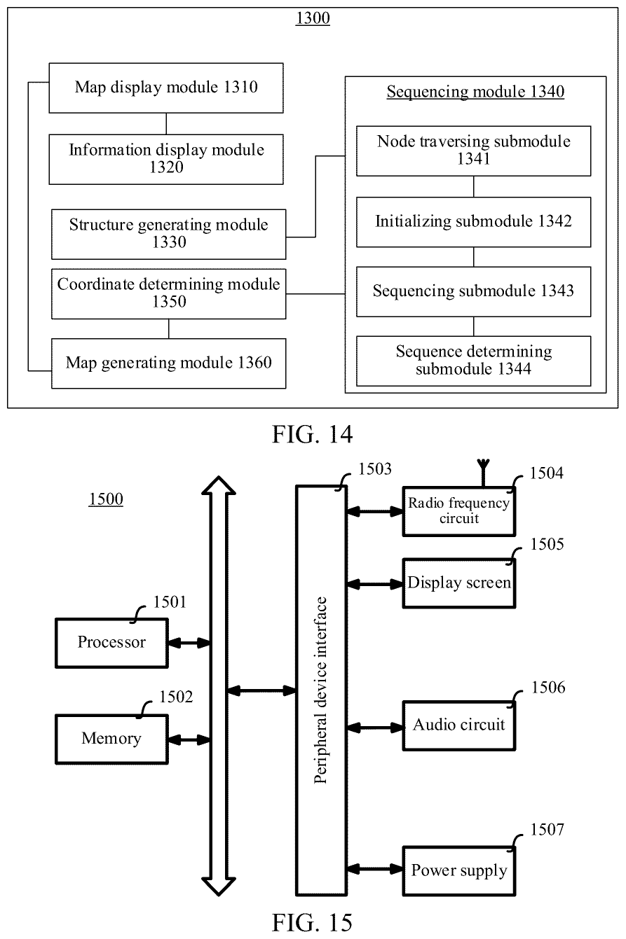

In some aspects, as shown in FIG. 14, the apparatus 1300 further includes: a structure generating module 1330, a sequencing module 1340, a coordinate determining module 1350 and a map generating module 1360.

The structure generating module 1330 is configured to generate a tree structure corresponding to the event sequence data set. Each node in the tree structure corresponds to one event, each node in the tree structure has a corresponding event sequence data group, and an event sequence data group corresponding to a first node in the tree structure includes: at least one piece of event sequence data regarding an event corresponding to the first node as a last event.

The sequencing module 1340 is configured to sequence each of the event sequence data in the event sequence data set based on the tree structure to obtain an event sequence data list.

The coordinate determining module 1350 is configured to map each of the event sequence data in the event sequence data list into a two-dimensional space, and determine two-dimensional space coordinates respectively corresponding to each of the event sequence data.

The map generating module 1360 is configured to draw polygons respectively corresponding to each of the event sequence data according to the two-dimensional space coordinates respectively corresponding to each of the event sequence data to obtain the graphic.

In some aspects, as shown in FIG. 14, the structure generating module 1330 is configured to:
generate the root node of the tree structure;
traverse each of the event sequence data in the event sequence data set, and determine the root node as a current node;
traverse each event in the event sequence data according to an occurrence sequence order of each event in the event sequence data, determine a node corresponding to the event as the current node in a case that the node corresponding to the event exists in child nodes of the current node, and search a next event in the event sequence data until all events in the event sequence data are traversed; add the node corresponding to the event in the child nodes of the current node in a case that no node corresponding to the event exists in the child nodes of the current node, determine the node corresponding to the event as the current node, and search a next event in the event sequence data until all events in the event sequence data are traversed; and
after the traversal of all event sequence data in the event sequence data set is finished, construct and obtain the tree structure corresponding to the event sequence data set.

In some aspects, as shown in FIG. 14, the sequencing module 1340 includes: a node traversing submodule 1341, an initializing submodule 1342, a sequencing submodule 1343, and a sequence determining submodule 1344.

The node traversing submodule 1341 is configured to traverse each node in the tree structure from the root node of the tree structure.

The initializing submodule 1342 is configured to initialize the root node into the first node.

The sequencing submodule 1343 is configured to sequence each child node of the first node in a depth ascending order to obtain a child node sequence of the first node. A depth of the child nodes refers to a layer number of descendant nodes included in the child nodes.

The sequencing submodule 1343 is further configured to resequence the first node and each child node in the child node sequence of the first node to obtain the node sequence corresponding to the first node.

The sequence determining submodule 1344 is configured to determine the node sequence corresponding to the first node as a complete node sequence.

The sequence determining submodule 1344 is further configured to determine the first child node as the first node to obtain the node sequence corresponding to the first node, and replace the first node in the complete node sequence by the node sequence corresponding to the first node to obtain an updated complete node sequence if a first child node of the first node has descendant nodes.

The sequence determining submodule 1344 is further configured to determine a last updated complete node sequence as a final complete node sequence after the traversal of all nodes in the tree structure is finished.

The sequencing submodule 1343 is further configured to sequence the event sequence data included in the event sequence data group corresponding to each of the nodes according to the sequence of each of the nodes included in the final complete node sequence to obtain the event sequence data list.

In some aspects, as shown in FIG. 14, the sequencing submodule 1343 is configured to:
orderly sequence the child node of the first node and the first node to obtain the node sequence corresponding to the first node if a quantity of the child nodes of the first node is 1;
split the child node sequence of the first node into a first subsequence and a second subsequence according to an index of the child node if the quantity of the child nodes of the first node is greater than 1, the first subsequence including child nodes with odd number indexes, and the second subsequence including child nodes with even number indexes; and orderly sequence each child node in the first subsequence in an inverted sequence, the first node, and each child node in the second subsequence in an ordered sequence to obtain the node sequence corresponding to the first node.

In some aspects, as shown in FIG. 14, the coordinate determining module 1350 is configured to:
generate a two-dimensional space coordinate array in a length k based on a Gosper curve generation algorithm, the k being greater than or equal to a quantity N of the event sequence data included in the event sequence data list, and the k and the N being both positive integers; and
for i^{th} event sequence data in the event sequence data list, select a [i+(N−k)/2]^{th} two-dimensional space coordinate from the two-dimensional space coordinate array in the length k as a two-dimensional space coordinate corresponding to the i^{th} event sequence data, the i being a positive integer smaller than or equal to the N.

Based on the above, in the technical solutions provided by aspects of this disclosure, the event sequence data set is represented by using a graphic (such as a map) formed by splicing a plurality of polygons, each of the polygons is configured for representing one event sequence, a user is supported to operate by aiming at one polygon in the graphic, the event sequence data corresponding to the polygon may be checked, an effect of showing a plurality of event sequences and corresponding event sequence data through one graphic is achieved, each event sequence only occupies a region where one polygon in the graphic is located, and the compactness is higher. Therefore, a space utilization rate of a display image required for event sequence display is improved.

In addition, when the apparatus provided in the foregoing aspect implements the functions of the apparatus, only division of the foregoing functional modules is used as an example for description. In an actual application, the foregoing functions may be allocated to and completed by different functional modules according to requirements. That is, an internal structure of the device is divided into different functional modules, to complete all or some of the functions described above. Additionally, the apparatus provided in the foregoing aspects and the method aspects belong to the same concept. For details of a specific implementation process, reference may be made to the method aspects, and it is not repeated herein.

Referring to FIG. 15, FIG. 15 is a structural block diagram of a terminal device 1500 provided by an aspect of this disclosure. The terminal device 1500 may be an electronic device such as a mobile phone, a tablet computer, a game console, an ebook reader, a multimedia playback device, a wearable device, or a PC. The terminal device is configured to implement the event sequence data display method provided in the foregoing aspects. The terminal device may be the terminal device 15 in the implementation environment shown in FIG. 2. In an example, the terminal device 1500 includes: a processor 1501 (e.g., processing circuitry) and a memory 1502 (e.g., a non-transitory computer-readable storage medium).

The processor 1501 may include one or more processing cores, such as a 4-core processor or an 8-core processor. The processor 1501 may be implemented in at least one hardware form of digital signal processing (DSP), field-programmable gate arrays (FPGA), and programmable logic arrays (PLA). The processor 1501 may further include a main processor and a coprocessor. The main processor is a processor configured to process data in an awaken state, and is also referred to as a central processing unit (CPU). The coprocessor is a low-power-consumption processor configured to process data in a standby state. In some aspects, the processor 1501 may be integrated with a graphics processing unit (GPU). The GPU is configured to render and draw content needing to be displayed on a display screen. In some aspects, the processor 1501 may further include an artificial intelligence (AI) processor. The AI processor is configured to process computing operations related to machine learning.

The memory 1502 may include one or more computer-readable storage media. The computer-readable storage medium may be non-transient. The memory 1502 may further include a high-speed random access memory and a non-volatile memory, for example, one or more disk storage devices and flash storage devices. In some aspects, the non-transitory computer-readable storage medium in the memory 1502 is configured to store at least one instruction, at least one program, code sets, or instruction sets, and may be configured to be executed by one or more processors to implement the foregoing event sequence data display method.

In some aspects, the terminal device 1500 may further include: a peripheral device interface 1503 and at least one peripheral device. The processor 1501, the memory 1502, and the peripheral device interface 1503 may be connected through a bus or a signal cable. Each peripheral device may be connected to the peripheral device interface 1503 through the bus, the signal cable, or a circuit board. Specifically, the peripheral device includes: at least one of a radio frequency circuit 1504, a display screen 1505, an audio circuit 1506, or a power supply 1507.

A person skilled in the art may understand that the structure shown in FIG. 15 constitutes no limitation to the terminal device 1500, and the terminal device may include more or fewer components than those shown in the figure, or some components may be combined, or a different component deployment may be used.

In an aspect, a computer-readable storage medium is further provided. The storage medium has a computer program stored therein, and the computer program, when executed by the processor, implements the foregoing event sequence data display method.

In some aspects, the computer-readable storage medium may include: a read-only memory (ROM), a random-access memory (RAM), a solid state drive (SSD), an optical disc, or the like. The RAM may include a resistance random access memory (ReRAM) and a dynamic random access memory (DRAM).

In an aspect, a computer program product is further provided. The computer program product includes a computer program, and the computer program is stored in a computer-readable storage medium such as a non-transitory computer-readable storage medium. A processor of a computer device reads the computer program from the computer-readable storage medium and executes the computer program to enable the computer device to implement the foregoing event sequence data display method.

In addition, according to the aspects of this disclosure, a prompt interface or a pop-up window may be displayed, or voice prompt information may be outputted before and during collecting user-related data of a user. The prompt interface, the pop-up window, or the voice prompt information is used for prompting the user that data related to the user is currently being collected, so that this application only starts to perform related operations of obtaining the user-related data after obtaining a confirmation operation of the user for the prompt interface or the pop-up window, otherwise (i.e., when the confirmation operation of the user for the prompt interface or the pop-up window is not obtained), ends the related operations of obtaining the user-related data, that is, skips obtaining the user-related data.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

“Plurality of” mentioned in the specification means two or more. “And/or” describes an association relationship for describing associated objects and represents that three relationships may exist. For example, A and/or B may represent the following three cases: only A exists, both A and B exist, and only B exists. The character “/” in this specification indicates an “or” relationship between the associated objects.

The foregoing descriptions are merely examples of aspects of this disclosure, and are not intended to limit this disclosure. Any modification, equivalent replacement, or improvement made within the spirit and principle of this disclosure shall fall within the protection scope of this disclosure.

What is claimed is:

1. A method for displaying event sequence data, the method comprising:
displaying a visual representation corresponding to an event sequence data set, the visual representation being formed by splicing a plurality of polygons, each of the plurality of polygons corresponding to a respective piece of the event sequence data in the event sequence data set, the respective piece of the event sequence data indicating a sequence formed by events; and
when an operation is performed on a first polygon in the visual representation, displaying the event sequence data corresponding to the first polygon.

2. The method according to claim 1, wherein the visual representation is divided into a plurality of regions, each of the plurality of regions including different event sequence data and including polygons from the plurality of polygons corresponding to the same event sequence data.

3. The method according to claim 2, wherein each of the plurality of regions has an edge contour, and different regions of the plurality of regions are associated with different edge contours.

4. The method according to claim 1, wherein each polygon of the plurality of polygons corresponding to the same event sequence data has the same appearance, and the polygons corresponding to different event sequence data have different appearances.

5. The method according to claim 4, wherein the appearance is color.

6. The method according to claim 1, wherein attribute marks are displayed inside the polygons, and the attribute marks indicate one or more attribute parameters of the event sequence data corresponding to the polygons.

7. The method according to claim 6, wherein the attribute marks indicate different attribute parameters.

8. The method according to claim 7, wherein sizes of the attribute marks are based on values of the attribute parameters.

9. The method according to claim 1, wherein the displaying the event sequence data comprises:
when a first operation is performed on the first polygon, displaying basic information of the event sequence data corresponding to the first polygon; and
when a second operation is performed on the first polygon, displaying detailed information of the event sequence data corresponding to the first polygon.

10. The method according to claim 1, wherein the displaying the visual representation comprises:
displaying each piece of the event sequence data in the event sequence data set in a list form; and
when a display mode switching operation is performed, displaying the visual representation corresponding to the event sequence data set.

11. The method according to claim 1, wherein each polygon of the plurality of polygons is a regular hexagon.

12. The method according to claim 1, further comprising:
generating a tree structure corresponding to the event sequence data set, wherein each node except for a root node in the tree structure corresponds to an event, each node except for the root node in the tree structure is associated with an event sequence data group, the event sequence data group associated with a selected node in the tree structure including at least one piece of the event sequence data having an event corresponding to the selected node as a last event;
sequencing each piece of the event sequence data in the event sequence data set based on the tree structure to obtain an ordered event sequence data list;
mapping each piece of the event sequence data in the ordered event sequence data list into a two-dimensional space to determine two-dimensional space coordinates for each piece of the event sequence data; and
wherein the displaying the visual representation includes displaying the visual representation with the polygons corresponding to each piece of the event sequence data based on the determined two-dimensional space coordinates.

13. The method according to claim 12, wherein the generating the tree structure comprises:
generating the root node of the tree structure;
for each piece of the event sequence data in the event sequence data set, determining the root node as a current node;
traversing each of a plurality of events in the respective piece of the event sequence data based on an occurrence order of the events in the respective piece of the event sequence data, wherein
when a child node corresponding to the respective traversed event is included in the child nodes of the current node, updating the current node to the child node and proceeding to a next event;
when the child node corresponding to the respective traversed event is not included in the child nodes of the current node, adding a new child node corresponding to the currently traversed event under the current node, updating the current node to the new child node; and
after the pieces of the event sequence data in the event sequence data set have been traversed, constructing the tree structure corresponding to the event sequence data set.

14. An apparatus, comprising:
processing circuitry configured to:
display a visual representation corresponding to an event sequence data set, the visual representation being formed by splicing a plurality of polygons, each of the plurality of polygons corresponding to a respective piece of event sequence data in the event sequence data set, the respective piece of the event sequence data indicating a sequence formed by events; and
when an operation is performed on a first polygon in the visual representation, display the event sequence data corresponding to the first polygon.

15. The apparatus according to claim 14, wherein the visual representation is divided into a plurality of regions, each of the plurality of regions including different event sequence data and including respective polygons from the plurality of polygons corresponding to the same event sequence data.

16. The apparatus according to claim 15, wherein each of the plurality of regions has an edge contour, and different regions of the plurality of regions are associated with different edge contours.

17. The apparatus according to claim 14, wherein each polygon of the plurality of polygons corresponding to the same event sequence data has the same appearance, and the polygons corresponding to different event sequence data have different appearances.

18. The apparatus according to claim 17, wherein the appearance is color.

19. The apparatus according to claim 14, wherein attribute marks are displayed inside the polygons, and the attribute marks indicate one or more attribute parameters of the event sequence data corresponding to the polygons.

20. A non-transitory computer-readable storage medium storing instructions which, when executed by a processor, cause the processor to perform:
displaying a visual representation corresponding to an event sequence data set, the visual representation being formed by splicing a plurality of polygons, each of the plurality of polygons corresponding to a respective piece of event sequence data in the event sequence data set, the respective piece of the event sequence data indicating a sequence formed by events; and
when an operation is performed on a first polygon in the visual representation, displaying the event sequence data corresponding to the first polygon.
